(19) United States
(12) Patent Application Publication
(10) Pub. No.: US 2024/0176677 A1
(43) Pub. Date: May 30, 2024

(54) ENERGY EFFICIENT SCALING OF MULTI-ZONE CONTAINER CLUSTERS

(71) Applicant: INTERNATIONAL BUSINESS MACHINES CORPORATION, ARMONK, NY (US)

(72) Inventors: Alaa S. Youssef, Valhalla, NY (US); Asser Nasreldin Tantawi, Somers, NY (US); Tamar Eilam, NEW YORK, NY (US)

(21) Appl. No.: 18/059,509

(22) Filed: Nov. 29, 2022

(51) Int. Cl. G06F 9/50

(52) U.S. Cl. CPC G06F 9/5094; G06F 9/5072; G06F 2209/501; G06F 2209/505

(57) ABSTRACT

An embodiment for improved methods for energy efficient scaling of multi-zone container clusters is provided. The embodiment may establish a connection between an upper layer container orchestration controller associated with multiple container cluster zones and lower layer resource manager controllers corresponding to multiple datacenters. The embodiment may determine additional workers are needed to perform a task and request worker offers from the lower layer resource manager controllers. The embodiment may receive the worker offers including worker profile data at the upper layer container orchestration controller. The embodiment may utilize the upper layer container orchestration controller to determine estimated expected utilization and corresponding incremental power consumption for each of the received worker offers, utilize the upper layer container orchestration controller to accept the received worker offer corresponding to a most energy efficient worker, and add the most energy efficient worker to a target cluster.

### BACKGROUND

The present application relates generally to container orchestration systems, and more particularly, to energy efficient scaling of multi-zone container clusters.

Businesses utilize orchestration systems for automating deployment, scaling, and management of containerized applications. Containers are lightweight packages of application code together with dependencies such as specific versions of programming language, runtimes, and libraries required to run a given software service. Such containers make it easy to share CPU, memory, storage, and network resources at the operating systems level and offer a logical packaging mechanism in which applications can be abstracted from the environment in which they run. Orchestration systems further include container clusters having sets of nodes (workers) configured to run containerized applications. Actively scaling up or down the number of workers being utilized at any given time to reflect workload demand changes, especially in environments containing multi-zone container clusters, is a critical process that is directly related to several important business considerations including, for example, performance, cost, and energy efficiency.

### SUMMARY

According to one embodiment, a method, computer system, and computer program product for carrying out improved methods for energy efficient scaling of multi-zone container clusters is provided. The embodiment may include establishing a connection between an upper layer container orchestration controller associated with multiple container cluster zones and lower layer resource manager controllers corresponding to multiple datacenters. The embodiment may also include determining additional workers are needed to perform a task. The embodiment may further include requesting worker offers from the lower layer resource manager controllers by sending signals from the upper layer container orchestration controller. The embodiment may further include receiving the worker offers including worker profile data at the upper layer container orchestration controller. The embodiment may also include utilizing the upper layer container orchestration controller to determine estimated expected utilization and corresponding incremental power consumption for each of the received worker offers. The embodiment may also include utilizing the upper layer container orchestration controller to accept the received worker offer corresponding to a most energy efficient worker. The embodiment may further include adding the most energy efficient worker to a target cluster.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for a process of energy efficient scaling of multi-zone container clusters in which additional workers are needed according to at least one embodiment;

FIG. 3 illustrates an operational flowchart for a process of energy efficient scaling of multi-zone container clusters in which removal of excess workers is needed according to at least one embodiment; and

FIG. 4 depicts an exemplary framework for energy efficient scaling of multi-zone container clusters according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate to container orchestration systems, and more particularly, to energy efficient scaling of multi-zone container clusters. The following described exemplary embodiments provide a system, method, and program product to, among other things, establish a connection between an upper layer container orchestration controller associated with multiple container cluster zones and lower layer resource manager controllers corresponding to multiple datacenters, determine additional workers are needed to perform a task, request worker offers from the lower layer resource manager controllers by sending signals from the upper layer container orchestration controller, and receive the worker offers including worker profile data at the upper layer container orchestration controller. The described exemplary embodiments may then utilize the upper layer container orchestration controller to determine estimated expected utilization and corresponding incremental power consumption for each of the received worker offers, utilize the upper layer container orchestration controller to accept the received worker offer corresponding to a most energy efficient worker, and add the most energy efficient worker to a target cluster. Therefore, the presently described embodiments have the capacity to improve energy efficient scaling of multi-zone container clusters by providing for a process in which the connected upper layer container orchestration controller (associated with multiple container cluster zones) and the lower layer resource manager controllers (corresponding to multiple datacenters) are able to effectively communicate with each other in order to share worker profile data. This enables the upper layer container orchestration controller to be effective in utilizing the shared worker profile data to then determine estimated utilizations and corresponding incremental power consumptions to determine a most energy efficient worker to be selected from multiple worker offers.

As previously described, businesses utilize orchestration systems for automating deployment, scaling, and management of containerized applications. Containers are lightweight packages of application code together with dependencies such as specific versions of programming language, runtimes, and libraries required to run a given software service. Such containers make it easy to share CPU, memory, storage, and network resources at the operating systems level and offer a logical packaging mechanism in which applications can be abstracted from the environment in which they run. Orchestration systems further include container clusters having sets of nodes (workers) configured to run containerized applications. Actively scaling up or down the number of workers being utilized at any given time to reflect workload demand changes, especially in environments containing multi-zone container clusters, is a critical process that is directly related to several important business considerations including, for example, performance, cost, and energy efficiency.

In many orchestration systems, scaling to add or remove workers has a direct effect on influencing power consumption. As power consumption increases, the carbon footprint for the operation increases. Many businesses are becoming increasingly concerned with minimizing carbon footprints and addressing energy efficiency concerns for a variety of reasons related to at least, the environment, performance, costs, and image. However, addressing energy efficiency concerns in the context of container orchestration systems is challenging as there may be sources of heterogeneity in server energy efficiency due to several factors. For example, server model and inherent power consumption profiles may differ. Additionally, the current operating point of a given server is a dynamically changing parameter. The relationship between server power consumption and utilization is not linear. Depending on the current utilization of the server, adding incremental workload may increase power consumption by a big or small amount for the same incremental workload (e.g., incoming container). Other servers may include proactive server power manager on the server which may put the server in a low power/frequency profile based on its utilization. Thus, scaling to add or remove workers in less sophisticated orchestration systems can lead to many inefficiencies relating to energy efficiency, cost, and performance if the above-described factors are unaccounted for. As stated above, many businesses are becoming increasingly concerned with minimizing carbon footprints and addressing energy efficiency concerns for a variety of reasons related to at least, the environment, performance, costs, and image.

Accordingly, a method, computer system, and computer program product for improved energy efficient scaling of multi-zone container clusters would be advantageous. The method, system, and computer program product may establish a connection between an upper layer container orchestration controller associated with multiple container cluster zones and lower layer resource manager controllers corresponding to multiple datacenters. The method, system, computer program product may determine additional workers are needed to perform a task. The method, system, computer program product may then request worker offers from the lower layer resource manager controllers by sending signals from the upper layer container orchestration controller. Next, the method, system, computer program product may receive the worker offers including worker profile data at the upper layer container orchestration controller. The method, system, computer program product may then utilize the upper layer container orchestration controller to determine estimated expected utilization and corresponding incremental power consumption for each of the received worker offers. Next, the method, system, computer program product may utilize the upper layer container orchestration controller to accept the received worker offer corresponding to a most energy efficient worker. Thereafter, the method, system, computer program product may add the most energy efficient worker to a target cluster. In turn, the method, system, computer program product has provided improved methods of energy efficient scaling of multi-zone container clusters by providing for a process in which the connected upper layer container orchestration controller (associated with multiple container cluster zones) and the lower layer resource manager controllers (corresponding to multiple datacenters) are able to effectively communicate with each other in order to share worker profile data. This enables the upper layer container orchestration controller to be effective in utilizing the shared worker profile data to then determine estimated utilizations and corresponding incremental power consumptions to subsequently determine a most energy efficient worker to be selected from the multiple worker offers.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

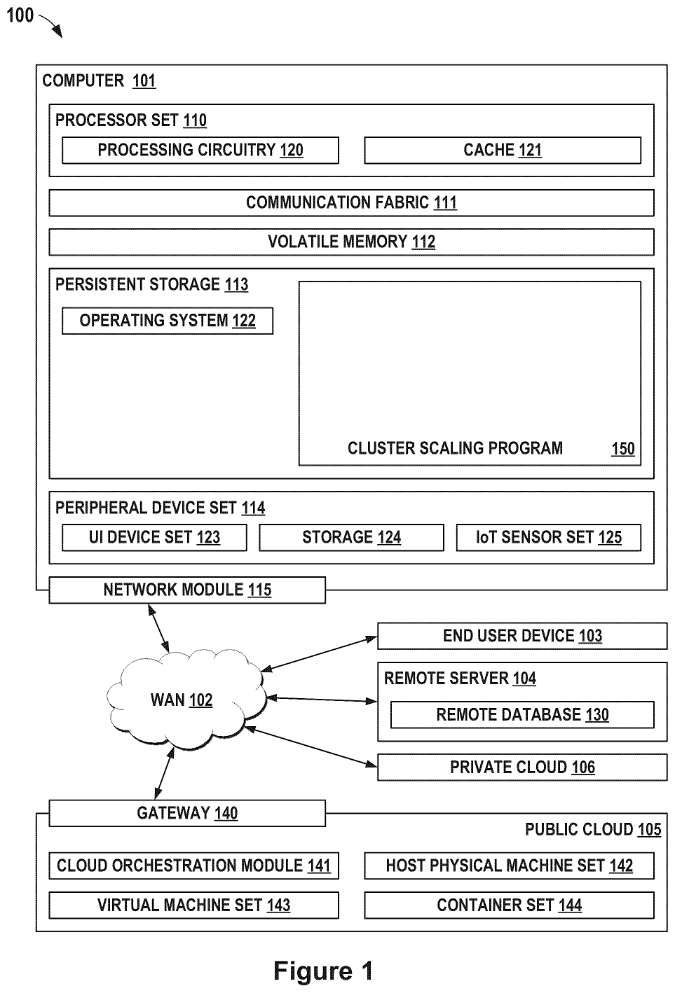

Referring now to FIG. 1, computing environment 100 contains an example of an environment for the execution of at least some of the computer code involved in performing the inventive methods, such as cluster scaling program/code 150. In addition to cluster scaling code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and cluster scaling code 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in cluster scaling code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in cluster scaling program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the cluster scaling program 150 may be a program capable of establishing a connection between an upper layer container orchestration controller associated with multiple container cluster zones and lower layer resource manager controllers corresponding to multiple datacenters. Cluster scaling program 150 may then determine additional workers are needed to perform a task. Next, cluster scaling program 150 may request worker offers from the lower layer resource manager controllers by sending signals from the upper layer container orchestration controller. Then, cluster scaling program 150 may receive the worker offers including worker profile data at the upper layer container orchestration controller. Thereafter, cluster scaling program 150 may utilize the upper layer container orchestration controller to determine estimated expected utilization and corresponding incremental power consumption for each of the received worker offers. Then, cluster scaling program 150 may utilize the upper layer container orchestration controller to accept the received worker offer corresponding to a most energy efficient worker. Thereafter, cluster scaling program 150 may add the most energy efficient worker to a target cluster. In turn, cluster scaling program 150 has provided improved methods of energy efficient scaling of multi-zone container clusters by providing for a process in which the connected upper layer container orchestration controller (associated with multiple container cluster zones) and the lower layer resource manager controllers (corresponding to multiple datacenters) are able to effectively communicate with each other in order to share worker profile data. This enables the upper layer container orchestration controller to be effective in utilizing the shared worker profile data to then determine estimated utilizations and corresponding incremental power consumptions to subsequently determine a most energy efficient worker to be selected from the multiple worker offers.

Cluster scaling program 150 may be employed within any suitable orchestration system capable of deploying, scaling, and managing containerized applications. In exemplary embodiments, cluster scaling program 150 is usable with the Kubernetes orchestration system. Kubernetes is an open-source system for automating deployment, scaling, and management of containerized applications across clusters of hosts. Kubernetes supports a range of container tools, including Docker. Kubernetes deploys containers (i.e., workloads) to a plurality of nodes (e.g., a physical machine or virtual machine). In Kubernetes, the base unit of deployment is a pod, which is a group of containers that work together and therefore are logically grouped. If horizontal scaling of a pod is required, a plurality of replicated pods is distributed over a cluster of nodes. The term “Kubernetes” may be subject to trademark rights in various jurisdictions throughout the world and are used here only in reference to the products or services properly denominated by the marks to the extent that such trademark rights may exist.

In embodiments, cluster scaling program/code 150 may be wholly or partially integrated into certain components of an illustrative container orchestration system. For example, cluster scaling program 150 may be integrated into an exemplary upper layer container orchestration controller associated with multiple container cluster zones and exemplary lower layer resource manager controllers corresponding to multiple datacenters. In other embodiments, cluster scaling program/code 150 may instead be employed by a service provider as a service for offering end users green or energy efficient resources obtained from multiple data centers. In other embodiments, cluster scaling program 150 may instead be employed by a broker on top of multiple service providers. In these embodiments the broker may provide the functions of the upper layer container orchestration controller and may interact with multiple service provider agents configured to correspond to the lower layer resource manager controllers.

In some embodiments, cluster scaling program 150 may be employed within a Kubernetes orchestration system including an upper layer container orchestration controller referred to as an autoscaler, and lower layer resource manager controllers referred to as Infrastructure as a Service (IaaS) schedulers. Cluster scaling program 150 may be configured to control or influence the way in which certain layers within the orchestration system, for example, the autoscaler and the IaaS scheduler, communicate and interact.

In the context of this disclosure, an autoscaler automatically resizes a given cluster's node (worker) pools based on the demands of the workload. When demand is high, the autoscaler may add nodes to the node pool, and when demand is low the autoscaler may scale back down to a minimum designated size. This can increase the availability of workloads when needed while controlling costs.

In the context of this disclosure, an IaaS scheduler refers to a control plane component which assigns pods to worker nodes. The worker nodes are where the containers (pods) are scheduled to run. The IaaS scheduler may determine which workers (nodes) are valid placements for each pod in the scheduler's queue according to its constraints and available resources. IaaS schedulers that do not employ cluster scaling program/code 150 typically unilaterally ranks each valid worker/node and binds the pod to a target node.

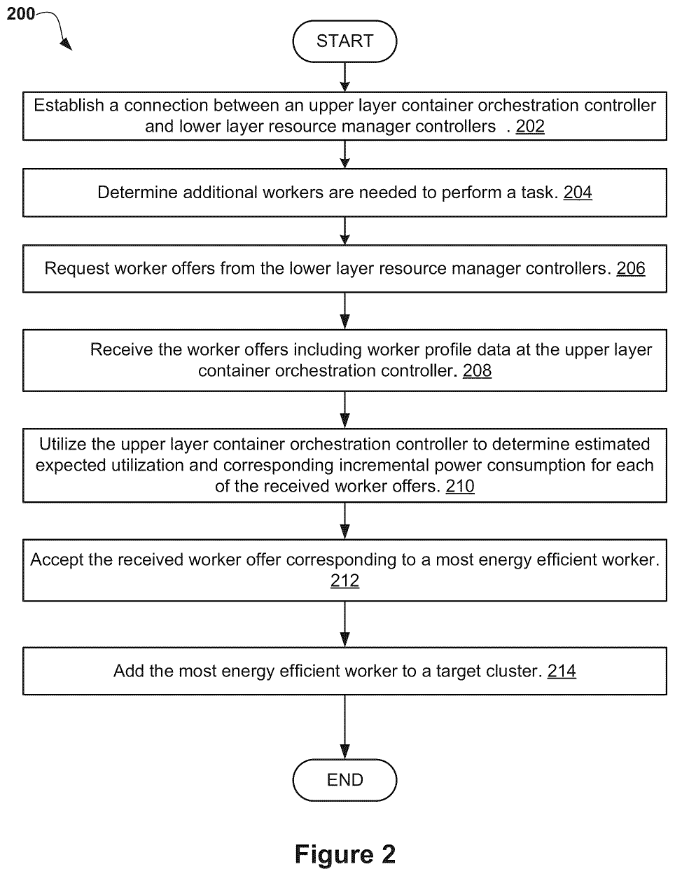

Referring now to FIG. 2, an operational flowchart for a process 200 for energy efficient scaling of multi-zone container clusters in which additional workers are needed according to at least one embodiment is provided.

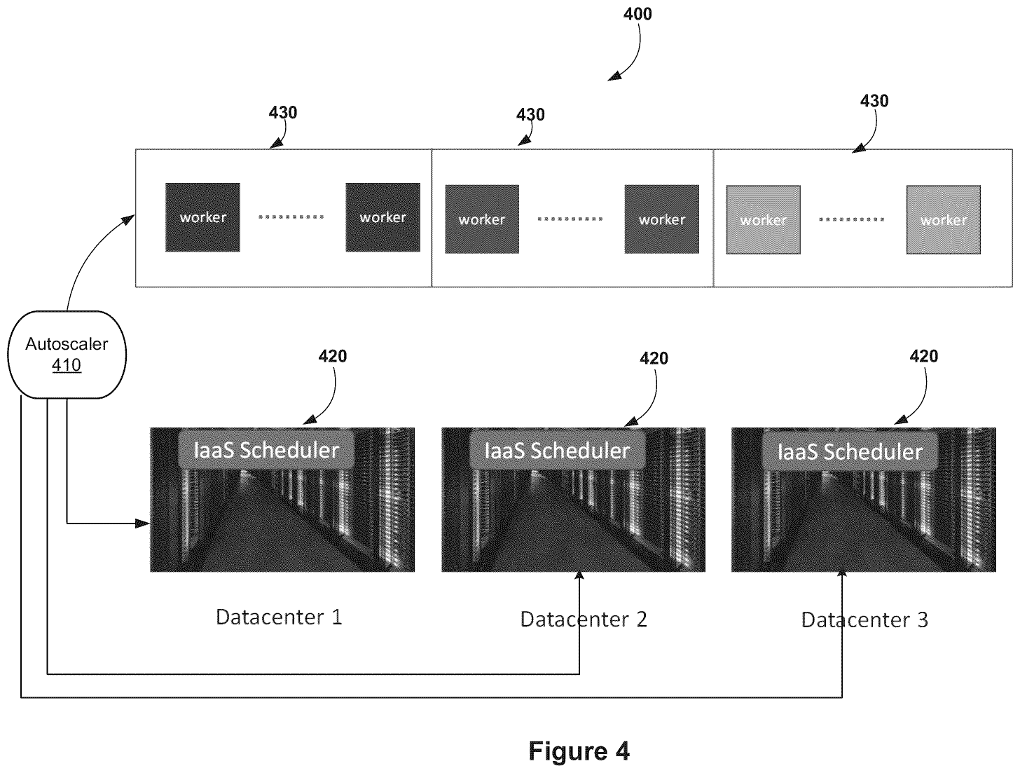

At 202, cluster scaling program 150 may establish a connection between an upper layer container orchestration controller associated with multiple container cluster zones and lower layer resource manager controllers corresponding to multiple datacenters. In an exemplary described embodiment referred to throughout this description (and partly illustrated in FIG. 4), cluster scaling program 150 may be employed in an exemplary Kubernetes orchestration system 400 in which cluster scaling program/code 150 is configured to enable an autoscaler 410 (upper layer container orchestration controller) to communicate with IaaS schedulers 420 (lower layer resource manager controllers) as well as a series of clusters 430.

At 204, cluster scaling program 150 may determine that additional workers are needed to perform a given task. To accomplish this, cluster scaling program 150 utilizes the upper layer container orchestration controller to consider observed current workloads, as well as predicted incoming loads, to determine if additional workers should be requested to perform a given task. In some exemplary embodiments, such as the described embodiment utilizing the Kubernetes orchestration system 400, the clusters used may allow containers to run across multiple machines and environments: virtual, physical, cloud-based, and on-premises.

Next, at 206, cluster scaling program 150 request worker offers from the lower layer resource manager controllers by sending signals from the upper layer container orchestration controller. Referring back to the above-discussed example involving exemplary Kubernetes orchestration system 400, this step may include, for example, cluster scaling program 150 utilizing the autoscaler 410 to send a signal to the IaaS scheduler 420 requesting worker offers. The sent worker offer request may include desired worker size with regards to CPU, memory, GPU's, etc. The sent worker offer request may further include other worker features such as network speed, i/o bandwidth, GPU model, storage type and capacity, etc. The requested workers (or offered workers at 208 discussed below) may be bare-metal or virtual workers.

Next, at 208, cluster scaling program 150 may receive the worker offers including worker profile data at the upper layer container orchestration controller. In the context of this disclosure, worker profile data may include current worker utilization, as well as a power profile as a function of utilization. In other words, a profile or curve that reflects how power consumption is expected to change as the utilization percentage goes up. In embodiments, the expected power consumption may be represented numerically and standardized to be a number between 0 and 1, where 0 represents no power consumption and 1 represents a maximum power consumption value capable of being output by a given worker. Returning to the exemplary embodiment discussed above, at this step, cluster scaling program 150 may enable the IaaS schedulers 420 to send worker offers O1, O2, and O3 (Sent from IaaS schedulers S1, S2, S3) corresponding to workers (nodes) w1, w2, and w3. Each worker exemplary offer O1, O2, O3 may include current worker utilization for each corresponding worker w1, w2, w3 as well as a worker power profile. For example, worker offer O1 may include a worker w1 currently operating at 20 percent utilization, having a power profile indicating that expected power consumption for worker w1 will increase from 0.1 to 0.4 upon reaching, for example, 50 percent utilization. While this example references power consumption for a specific utilization percentage, the worker power profile may be used to estimate power consumption at any utilization percentage along the curve/profile.

At 210, cluster scaling program 150 may utilize the upper layer container orchestration controller to determine estimated expected utilization and corresponding incremental power consumption for each of the received worker offers. In other words, in response to receiving access to each worker offer, the upper layer container orchestration controller is now able to estimate where each worker would fall on its respective worker power profile if the worker was selected and added to the platform. For example, using the exemplary embodiment discussed above, at this step cluster scaling program 150 may be configured to utilize autoscaler 410 to determine the estimated expected utilization and corresponding incremental power consumption for each of the received worker offers O1, O2, and O3. For example, autoscaler 410 may determine that worker offer O1 would be expected to involve worker w1 increasing to 50 percent utilization upon being added to the platform, and would experience a corresponding incremental power consumption increase of 0.3, while a second worker offer O2 would be expected to involve worker w2 increasing to only 30 percent utilization upon being added to the platform, and involving a corresponding incremental power consumption increase of 0.05.

This above-described process at step 210 thus allows cluster scaling program 150 to utilize the upper layer container orchestration controller, in this example the autoscaler 410, to determine which of the received worker offers correspond to the most energy efficient worker. In embodiments, cluster scaling program 150 may be configured to enable upper layer container orchestration controller to consider a variety of additional contributing factors (other than the estimated percent utilization increase and corresponding incremental power consumption change discussed above) when selecting an ideal worker. For example, cluster scaling program 150 may be configured to ensure that the carbon intensity of each data center is considered (particularly in multi-region clusters). In the context of this disclosure carbon intensity may be considered a function of the energy sources feeding a given datacenter and may vary with time. This is useful for calculating variations of a carbon footprint. For example, a carbon footprint may be estimated using a function of power utilization efficiency (PUE) of each datacenter, power consumption, and carbon intensity. Power utilization efficiency may typically be a constant average value measured per datacenter dependent upon cooling efficiency. These additional features may be useful considerations for businesses attempting to minimize their carbon footprint. Another example of additional contributing factors for selecting. Other additional features that may be considered for selecting an ideal worker may include performance (server sped) and cost per compute unit time. In embodiments, these contributing factors for selecting an ideal worker may be assigned subjective numerical weights (i.e. between 0 and 1) in any combination to reflect the priorities of a business. For example, in some embodiments, the upper layer container orchestration controller may be configured to prioritize energy efficiency relatively highly.

At 212, cluster scaling program 150 may automatically utilize the upper layer container orchestration controller to accept the received worker offer corresponding to a most energy efficient worker. As discussed above, cluster scaling program 150 is configured to enable the upper layer container orchestration controller to determine which received worker offer corresponds to the most energy efficient worker in view of the estimated utilization increases and corresponding expected incremental power consumption increases. Accordingly, at this step, cluster scaling program 150 utilizes the upper layer container orchestration controller to accept the received worker offer corresponding to the most energy efficient worker. For example, in the above-discussed example, cluster scaling program 150 may utilize autoscaler 410 at this step to accept the O2 offer sent by the IaaS scheduler S2 that involved an expected worker w2 increasing to only 30 percent utilization and an expected incremental power consumption increase of only 0.05. In this example, O2 was determined by autoscaler 410 to include the most energy efficient worker w2.

At 214, cluster scaling program 150 may add the most energy efficient worker to a target cluster. Cluster scaling program 150 may accomplish this by having the upper layer container orchestration controller add the most energy efficient worker to the platform and subsequently directing a workload to the added worker. Cluster scaling program 150 may further be configured to utilize the upper layer container orchestration controller reject the outstanding worker offers that did not contain the most energy efficient worker. It should be noted that requests for additional workers may be for a single worker, or multiple workers. If the request is for multiple workers, cluster scaling program 150 may accept as many worker offers (based upon energy efficiency as described above) as is needed to meet the received worker request, and reject the remaining offers.

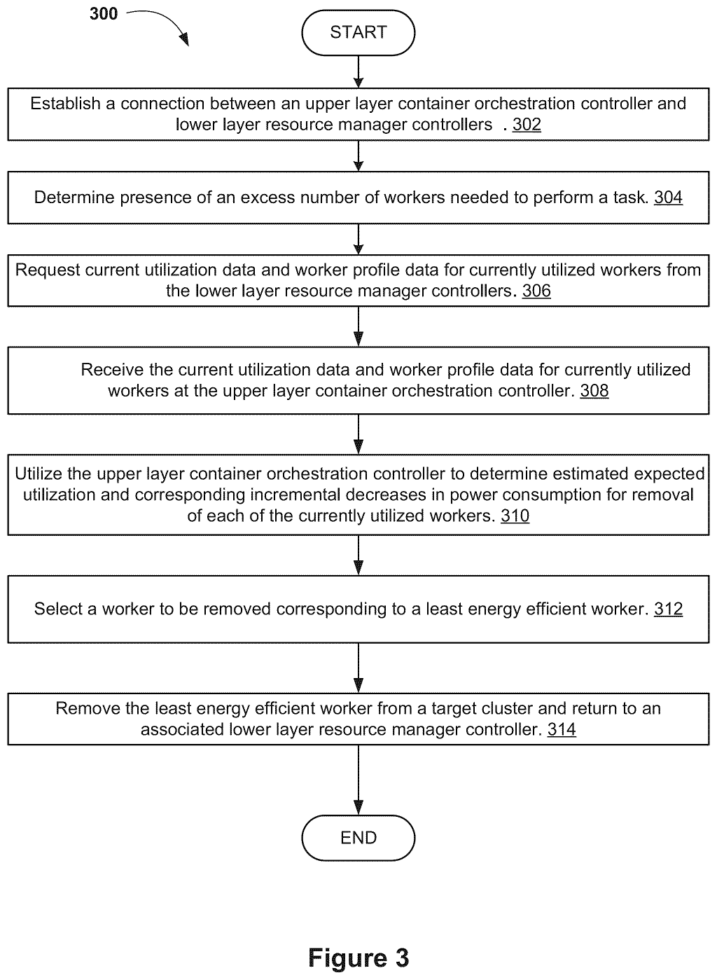

Referring now to FIG. 3, an operational flowchart is shown for a process 300 of energy efficient scaling of multi-zone container clusters in which removal of excess workers is needed according to at least one embodiment. This process improves energy efficiency of scaling by removing those workers that will lead to the most power reduction. Process 300 relies upon the same steps as described above to utilize cluster scaling program 150 to enable the upper layer container orchestration controller and lower layer resource manager controllers to share worker data, including utilization data and power profiles, to determine the least energy efficient worker. The least energy efficient worker may then be removed and returned to the lower layer resource manager controller.

In an exemplary embodiment employing cluster scaling program 150 in an illustrative Kubernetes orchestration system similar to the above-described example, process 300 may be carried out by cluster scaling program 150 utilizing autoscaler 410 and IaaS schedulers 420 as follows:

At 302, cluster scaling program 150 may establish a connection between the autoscaler 410 and the IaaS schedulers 420. At 304, autoscaler 410 may determine that one or more workers that are currently being utilized are no longer needed based on observing current workload and expected workloads. At 306, the autoscaler 410 may request worker power profiles and current worker server utilization data (if worker is a virtual machine) from one or more corresponding IaaS schedulers. At 308, the corresponding IaaS schedulers may send the current utilization data for the workers and worker power profiles to the autoscaler 410. After autoscaler 410 receives the current worker utilization data and worker power profiles at 308, it may then, at 310, estimate expected worker utilization reductions and corresponding incremental reductions in power consumption for removal of each of the currently utilized workers. Next, at 312, the autoscaler may select a least energy efficient worker corresponding to a least predicted reduction in power consumption upon removal. Finally, at 314, the autoscaler will remove the least energy efficient worker from a target cluster and return the worker to an associated IaaS scheduler.

It may be appreciated that cluster scaling program 150 has provided improved methods of energy efficient scaling of multi-zone container clusters by providing for a process in which the connected upper layer container orchestration controller (associated with multiple container cluster zones) and the lower layer resource manager controllers (corresponding to multiple datacenters) are able to effectively communicate with each other in order to share worker profile data. This enables the upper layer container orchestration controller to be effective in utilizing the shared worker profile data to then determine estimated utilizations and corresponding incremental power consumptions or reductions to subsequently determine a most or least energy efficient worker to be added or removed from a given environment.

It may be appreciated that FIGS. 2 and 3 provide only illustrations of exemplary implementations and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of energy efficient scaling of multi-zone cluster containers, the method comprising:
establishing a connection between an upper layer container orchestration controller associated with multiple container cluster zones and lower layer resource manager controllers corresponding to multiple datacenters;
determining additional workers are needed to perform a task;
requesting worker offers from the lower layer resource manager controllers by sending signals from the upper layer container orchestration controller;
receiving the worker offers including worker profile data at the upper layer container orchestration controller;
utilizing the upper layer container orchestration controller to determine estimated expected utilization and corresponding incremental power consumption for each of the received worker offers;
utilizing the upper layer container orchestration controller to accept the received worker offer corresponding to a most energy efficient worker; and
adding the most energy efficient worker to a target cluster.

2. The computer-based method of claim 1, wherein the upper layer container orchestration controller comprises a cluster autoscaler.

3. The computer-based method of claim 1, wherein the additional workers are selected from one of bare-metal workers or virtual machine workers.

4. The computer-based method of claim 1, wherein the lower layer resource manager controllers comprise infrastructure as a service (IaaS) schedulers.

5. The computer-based method of claim 1, wherein the worker profile data includes worker power profiles, the worker power profiles including expected power consumption at a given utilization value.

6. The computer-based method of claim 1, further comprising:
determining presence of an excess number of workers needed to perform a task at the target cluster; and
in response to determining presence of an excess number of workers needed to perform a task, utilizing the upper layer container orchestration controller to determine estimated expected utilization and corresponding incremental decreases in power consumption associated with removal of any given one of a series of currently utilized worker.

7. The computer-based method of claim 6, further comprising:
utilizing the upper layer container orchestration controller to select a least energy efficient worker to be removed from the target cluster; and
automatically removing the least energy efficient worker and returning the least energy efficient worker to an associated lower layer resource manager controller.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
establishing a connection between an upper layer container orchestration controller associated with multiple container cluster zones and lower layer resource manager controllers corresponding to multiple datacenters;
determining additional workers are needed to perform a task;
requesting worker offers from the lower layer resource manager controllers by sending signals from the upper layer container orchestration controller;
receiving the worker offers including worker profile data at the upper layer container orchestration controller;
utilizing the upper layer container orchestration controller to determine estimated expected utilization and corresponding incremental power consumption for each of the received worker offers;
utilizing the upper layer container orchestration controller to accept the received worker offer corresponding to a most energy efficient worker; and
adding the most energy efficient worker to a target cluster.

9. The computer system of claim 8, wherein the upper layer container orchestration controller comprises a cluster autoscaler.

10. The computer system of claim 8, wherein the additional workers are selected from one of bare-metal workers or virtual machine workers.

11. The computer system of claim 8, wherein the lower layer resource manager controllers comprise infrastructure as a service (IaaS) schedulers.

12. The computer system of claim 8, wherein the worker profile data includes worker power profiles, the worker power profiles including expected power consumption at a given utilization value.

13. The computer system of claim 8, further comprising:
determining presence of an excess number of workers needed to perform a task at the target cluster; and
in response to determining presence of an excess number of workers needed to perform a task, utilizing the upper layer container orchestration controller to determine estimated expected utilization and corresponding incremental decreases in power consumption associated with removal of any given one of a series of currently utilized worker.

14. The computer system of claim 13, further comprising:
utilizing the upper layer container orchestration controller to select a least energy efficient worker to be removed from the target cluster; and
automatically removing the least energy efficient worker and returning the least energy efficient worker to an associated lower layer resource manager controller.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
establishing a connection between an upper layer container orchestration controller associated with multiple container cluster zones and lower layer resource manager controllers corresponding to multiple datacenters;
determining additional workers are needed to perform a task;
requesting worker offers from the lower layer resource manager controllers by sending signals from the upper layer container orchestration controller;
receiving the worker offers including worker profile data at the upper layer container orchestration controller;
utilizing the upper layer container orchestration controller to determine estimated expected utilization and corresponding incremental power consumption for each of the received worker offers;
utilizing the upper layer container orchestration controller to accept the received worker offer corresponding to a most energy efficient worker; and
adding the most energy efficient worker to a target cluster.

16. The computer program product of claim 15, wherein the upper layer container orchestration controller comprises a cluster autoscaler.

17. The computer program product of claim 15, wherein the additional workers are selected from one of bare-metal workers or virtual machine workers.

18. The computer program product of claim 15, wherein the lower layer resource manager controllers comprise infrastructure as a service (IaaS) schedulers; and
wherein the worker profile data includes worker power profiles, the worker power profiles including expected power consumption at a given utilization value.

19. The computer program product of claim 15, further comprising:
determining presence of an excess number of workers needed to perform a task at the target cluster; and
in response to determining presence of an excess number of workers needed to perform a task, utilizing the upper layer container orchestration controller to determine estimated expected utilization and corresponding incremental decreases in power consumption associated with removal of any given one of a series of currently utilized worker.

20. The computer program product of claim 19, further comprising:
utilizing the upper layer container orchestration controller to select a least energy efficient worker to be removed from the target cluster; and
automatically removing the least energy efficient worker and returning the least energy efficient worker to an associated lower layer resource manager controller.
